(19) United States
(12) Patent Application Publication
(10) Pub. No.: US 2019/0242255 A1
(43) Pub. Date: Aug. 8, 2019

(54) System and Method for Preventing an Explosion of a Caldera

(71) Applicants: Igor Boris Mashinsky, Montreal (CA); Andrey Chernomyrdin, Moscow (RU); Makhmut Khamkhoev, Moscow (RU)

(72) Inventors: Igor Boris Mashinsky, Montreal (CA); Andrey Chernomyrdin, Moscow (RU); Makhmut Khamkhoev, Moscow (RU)

(21) Appl. No.: 16/269,196

(22) Filed: Feb. 6, 2019

Related U.S. Application Data
(60) Provisional application No. 62/627,295, filed on Feb. 7, 2018.

(51) Int. Cl. E21D 9/14; G21J 3/02; E21D 9/02

(52) U.S. Cl. CPC E21D 9/14; A62C 3/06; E21D 9/02; G21J 3/02

(57) ABSTRACT

A system and method of preventing an explosion of a natural caldera. The system includes an artificial caldera, formed by a spiral tunnel that extends from a surface of the earth to a position close to a surface of a magma plume of the natural caldera. A plurality of charges, such as tactical nuclear charges, are placed at positions along a length of the spiral tunnel, and detonated to form the artificial caldera. The method includes determining a center of the natural caldera, constructing the spiral tunnel, placing the plurality of charges within the spiral tunnel at fixed intervals, and detonating the plurality of charges simultaneously. Detonation of the plurality of charges opens the artificial caldera and allows magma thereunder to be controllably released through the artificial caldera. In this manner, a pressure of the magma is reduced, and a cataclysmic explosion of the natural caldera is mitigated.

### CROSS REFERENCE TO RELATED APPLICATIONS

This application claims priority under 35 U.S.C. § 119(e) to U.S. Provisional Application No. 62/627,295 filed on Feb. 7, 2018. The above identified patent application is incorporated by reference herein in its entirety to provide continuity of disclosure.

### BACKGROUND OF THE INVENTION

The present invention relates to a system and method for preventing an explosion of a caldera.

Calderas are formed following evacuation of a magma chamber of a volcano, and are an existential threat to life on earth due to their tendency to erupt. Upon eruption, calderas release tremendous quantities of volcanic magma, glass ash, and poisonous volcanic gases that can block out the sun. Such a blockage of the sun would leave the earth immersed in darkness for several years and decrease the environmental temperature, causing a new ice age.

Therefore, there is a need in the art for a system and method for preventing an explosion of a caldera. The present invention addresses this unmet need.

Systems have been disclosed in the art that relate to magma evacuation. These include systems that have been patented and published in patent application publications. These systems are often difficult to make or use. In view of the systems disclosed in the art, it is submitted that there is a need in the art for an improvement to existing magma evacuation systems. In view of the present disclosure, it is submitted that the present invention substantially diverges in structural and functional elements from systems in the art, and substantially fulfills an unmet need in the art.

### SUMMARY OF THE INVENTION

In view of the disadvantages inherent in the known types of magma evacuation systems in the art, the present invention provides an artificial caldera, wherein the same can be utilized for evacuating magma and preventing an explosion of a natural caldera.

It is therefore an object of the present invention to provide an artificial caldera, and a method of making the artificial caldera, for preventing an explosion of a natural caldera.

In one aspect, the invention provides a system for preventing an explosion of a natural caldera, comprising a spiral tunnel that extends from a surface of earth to a position near a surface of a magma plume of the natural caldera, and a plurality of charges disposed within the spiral tunnel.

In another aspect, the invention provides a method for preventing an explosion of the natural caldera, comprising creating an artificial caldera within the natural caldera.

Another object of the present invention is to provide an artificial caldera that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a schematic of an artificial caldera constructed within a natural caldera.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

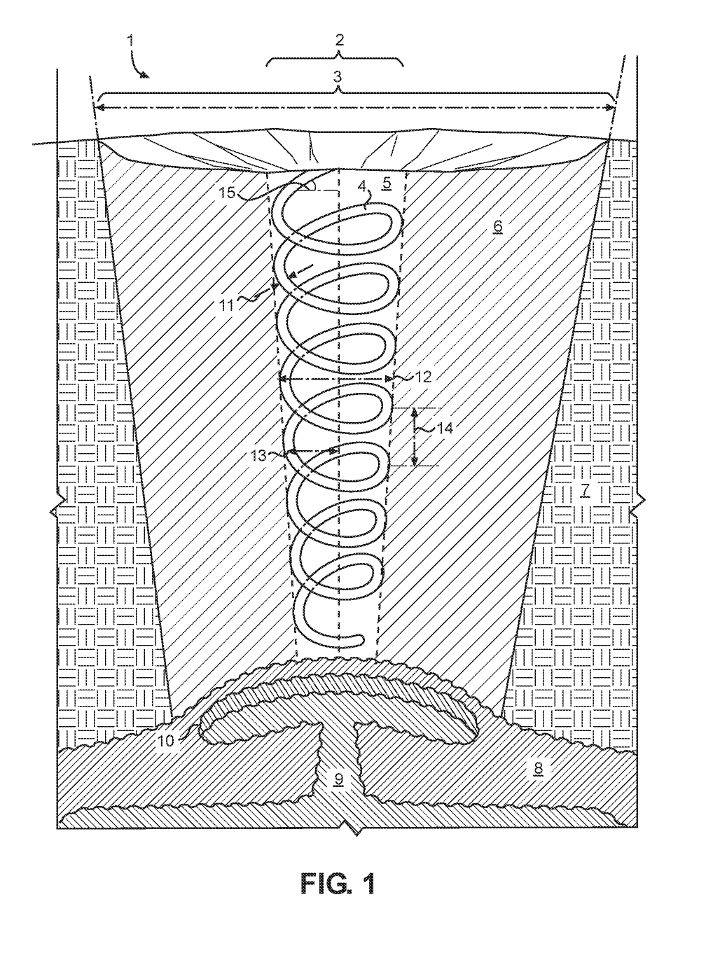

Referring now to FIG. 1, there is depicted a schematic of an artificial caldera constructed within a natural caldera. A system 1 for preventing an explosion of a natural caldera 3 includes an artificial caldera 2 engineered within the natural caldera 3. The system 1 includes a spiral tunnel 4 that extends from a surface of earth to a position near a surface of a magma plume of the natural caldera 3, and a plurality of charges disposed within the spiral tunnel.

Generally, the natural caldera 3 is characterized by at least a caldera body 6, a lithospheric plate 7, a plastic portion 8 of magma, a basaltic portion 9 of magma, and a granitic portion 10 of magma, as would be understood by a person having ordinary skill in the art. According to the present invention, the artificial caldera 2 is engineered within the natural caldera 3 so as to controllably release a magma from the natural caldera 3, and prevent an explosion of the natural caldera 3.

In one embodiment, a selection of charges of the plurality of charges are disposed within the spiral tunnel 4 at a fixed interval with respect to each other. In one embodiment, a selection of charges of the plurality of charges are nuclear charges. In one embodiment, the selection of charges of the plurality of charges includes each and every charge of the plurality of charges.

In a particular embodiment, the selection of charges of the plurality of charges are disposed within the spiral tunnel 4 at the fixed interval of about every 100 meters. In a particular embodiment, the spiral tunnel 4 includes a constant optimum tilt angle 15 of about 20 degrees. This value of the angle of inclination creates an immersion 14 of a gallery 5 of the artificial caldera 2 that is equal to about twice a size of a radius 13 of the artificial caldera 2. The radius 13 of the artificial caldera 2 can be any suitable or chosen value, such as 0.5 km, 1 km, 2 km, or any value therebetween, according to need. The spiral tunnel 4 may have a radius 11 of about 5 m to 6 m. Generally, the spiral tunnel 4 extends to a position close to the surface of the magma but does not reach it. A radius 12 of the coil of the spiral tunnel 4 correlates or coincides with a radius of the artificial caldera 2. In this manner, the artificial caldera 2 is sized and configured to controllably release a magma from the caldera, thereby preventing an explosion of the caldera.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

We claim:

1) A system for preventing an explosion of a natural caldera, comprising:
a spiral tunnel that extends from a surface of earth to a position near a surface of a magma plume of the natural caldera; and
a plurality of charges disposed within the spiral tunnel.

2) The system of claim 1, wherein a selection of charges of the plurality of charges are disposed within the spiral tunnel at a fixed interval with respect to each other.

3) The system of claim 2, wherein the selection includes each and every charge of the plurality of charges.

4) The system of claim 1, wherein a selection of charges of the plurality of charges are nuclear charges.

5) The system of claim 4, wherein the selection includes each and every charge of the plurality of charges.

6) A method for preventing an explosion of a natural caldera, comprising creating an artificial caldera within the natural caldera.

7) The method of claim 6, wherein the artificial caldera is formed by detonating a plurality of charges.

8) The method of claim 7, wherein the plurality of charges is placed within a spiral tunnel that extends from a surface of the earth to a position near a surface of a magma plume of the natural caldera.

9) The method of claim 8, wherein a selection of charges of the plurality of charges are nuclear charges.

10) The method of claim 9, wherein the selection includes each and every charge of the plurality of charges.
